(19) United States
(12) Patent Application Publication
(10) Pub. No.: US 2018/0097415 A1
(43) Pub. Date: Apr. 5, 2018

(54) SINGLE PHASE INDUCTION MOTOR AND WASHING MACHINE

(71) Applicant: GUANGDONG WELLING MOTOR MANUFACTURING CO., LTD., Foshan (CN)

(72) Inventors: Fei Wang, Foshan (CN); Hao Zhang, Foshan (CN); Xingxing Lu, Foshan (CN); Kaiping Wen, Foshan (CN); Jintao Chen, Foshan (CN)

(21) Appl. No.: 15/827,671

(22) Filed: Nov. 30, 2017

Related U.S. Application Data
(63) Continuation of application No. PCT/CN2015/096015, filed on Nov. 30, 2015.

(30) Foreign Application Priority Data
Jun. 1, 2015 (CN) 201510293536.1

(51) Int. Cl. H02K 3/12; H02K 7/116; H02K 7/108; D06F 37/30; D06F 37/36

(52) U.S. Cl. CPC H02K 3/12; H02K 7/116; D06F 37/36; D06F 37/304; H02K 7/108

(57) ABSTRACT

Provided are a single phase induction motor and a washing machine having the same. The single phase induction motor includes a stator and a rotor rotationally fitted with the stator, the stator includes a stator core and a stator winding disposed on the stator core, the rotor is of a squirrel cage type structure, and the single phase induction motor has two poles, a synchronous speed of 3000 rpm or 3600 rpm, and a rated speed ranging from 2200 rpm to 2800 rpm or ranging from 2600 rpm to 3400 rpm.

### CROSS-REFERENCE TO RELATED APPLICATION

This application is a continuation application of International Application PCT/CN2015/096015, filed Nov. 30, 2015, which claims priority to Chinese Patent Application No. 201510293536.1, filed with the State Intellectual Property Office of the People's Republic of China on Jun. 1, 2015, both of which are incorporated herein by reference in their entirety.

### TECHNICAL FIELD

The present disclosure relates to the field of motors, and more particularly to a single phase induction motor and a washing machine having the same.

### BACKGROUND

The existing single phase induction motor for a pulsator washing machine is a four-pole motor and has a synchronous speed of 1500 rpm (a power frequency of 50 Hz) or 1800 rpm (a power frequency of 60 Hz). The working principle of this washing machine is that the speed of the four-pole motor is reduced down to about 750 to 800 rpm by a primary reduction member to drive a container to rotate under a dehydrating condition, and to about 210 to 260 rpm by the primary reduction member and a secondary reduction member to drive the container to rotate under a washing condition.

The existing pulsator washing machine has the following shortcomings in the specific application: the motor for driving the container to rotate is the four-pole motor with a relatively low synchronous speed of 1500 rpm (the power frequency of 50 Hz) or 1800 rpm (the power frequency of 60 Hz), which results in a larger output torque under the same output power and a larger motor volume as the motor volume is directly proportional to the output torque, such that the space occupied by the motor in the washing machine is relatively large, thereby hindering the optimization design of the internal spatial structure of the washing machine.

### SUMMARY

For overcoming the shortcomings in the related art, embodiments of the present disclosure provide a single phase induction motor and a washing machine having the same, which solves the problem that the space occupied by the existing single phase induction motor in the washing machine is relatively large.

To achieve the above purpose, in embodiments of the present disclosure, there is provided a single phase induction motor for a washing machine, including: a stator and a rotor rotationally fitted with the stator, the stator includes a stator core and a stator winding disposed on the stator core, the rotor is of a squirrel cage type structure, and the single phase induction motor has two poles, a synchronous speed of 3000 rpm (a power frequency of 50 Hz) or 3600 rpm (a power frequency of 60 Hz) and a rated speed ranging from 2200 rpm to 2800 rpm (the power frequency of 50 Hz) or ranging from 2600 rpm to 3400 rpm (the power frequency of 60 Hz).

Alternatively, an inner hole is formed inside the stator core to allow the rotor to pass through the inner hole, the stator core includes two first outer edges opposite and parallel to each other and two second outer edges opposite and parallel to each other, and a distance between the two first outer edges is less than or equal to a distance between the two second outer edges.

Alternatively, a ratio of a diameter of the inner hole to the distance between the two first outer edges is less than or equal to 0.49:1.

Alternatively, the distance between the two first outer edges is 116±5 mm.

Alternatively, the stator core defines a plurality of winding slot groups for accommodating the stator winding, each of the plurality of winding slot groups includes four first slots and two second slots, and a recessed depth of each second slot is greater than that of each first slot.

Alternatively, in the same winding slot group, the two second slots are disposed adjacent to each other and located on the same side of the four first slots.

Alternatively, a ratio of a slot surface area of each second slot to that of each first slot is greater than or equal to 1.36:1.

Alternatively, the stator core defines four winding slot groups, the stator core has four corners at outer edges thereof, and the second slots of the four winding slot groups are opposite to the four corners at the outer edges of the stator core, respectively.

Alternatively, the stator winding includes a primary winding and a secondary winding, the first slots are each provided with the primary winding or the secondary winding therein, and the second slots are each provided with at least one of the primary winding or the secondary winding therein.

Further, in embodiments of the present disclosure, there is provided a washing machine, including a container; a motor configured to drive the container to rotate; and a transmission control mechanism connected between the container and the motor, the motor is the single phase induction motor as described above, and the rotor is connected with the container via the transmission control mechanism.

Alternatively, a rotation central axis of the container is a vertical axis.

Alternatively, the transmission control mechanism includes a clutch connected with the rotor and a reduction transmission component connected between the clutch and the container.

Alternatively, the reduction transmission component includes a primary reduction member and a secondary reduction member, the single phase induction motor is configured to drive the container to rotate at a speed ranging from 750 rpm to 800 rpm through a transmission between the clutch and the primary reduction member; or the single phase induction motor is configured to drive the container to rotate at a speed ranging from 210 rpm to 260 rpm through a transmission among the clutch, the primary reduction member and the secondary reduction member.

### BRIEF DESCRIPTION OF THE DRAWINGS

FIG. 1 is a schematic view of a stator according to an embodiment of the present disclosure; and

FIG. 2 is a schematic view illustrating a coordination of a stator and a rotor according to an embodiment of the present disclosure.

### DETAILED DESCRIPTION

In order to make objectives, technical solutions and advantages of the present disclosure clearer, implementations of the present disclosure will be described in detail below with reference to drawings and embodiments. It will be appreciated that, the specific embodiments described herein is merely used to generally understand the present disclosure, and shall not be construed to limit the present disclosure.

It should be illustrated that, in the present disclosure, unless specified or limited otherwise, the terms “mounted,” “connected,” “arranged,” “fixed” and the like are used broadly, and may be, for example, fixed connections, detachable connections, or integral connections; may also be mechanical or electrical connections; may also be direct connections or indirect connections via intervening structures; may also be inner communications of two elements, which can be understood by those skilled in the art according to specific situations.

In the specification, it is to be understood that terms such as “left,” “right,” “upper,” “lower,” “top,” “bottom,” “inner,” and “outer,” should be construed to refer to the orientation as then described or as shown in the drawings under discussion. These relative terms are for convenience of description or are referenced to normal usage states of products, and thus shall not be construed to limit the present disclosure.

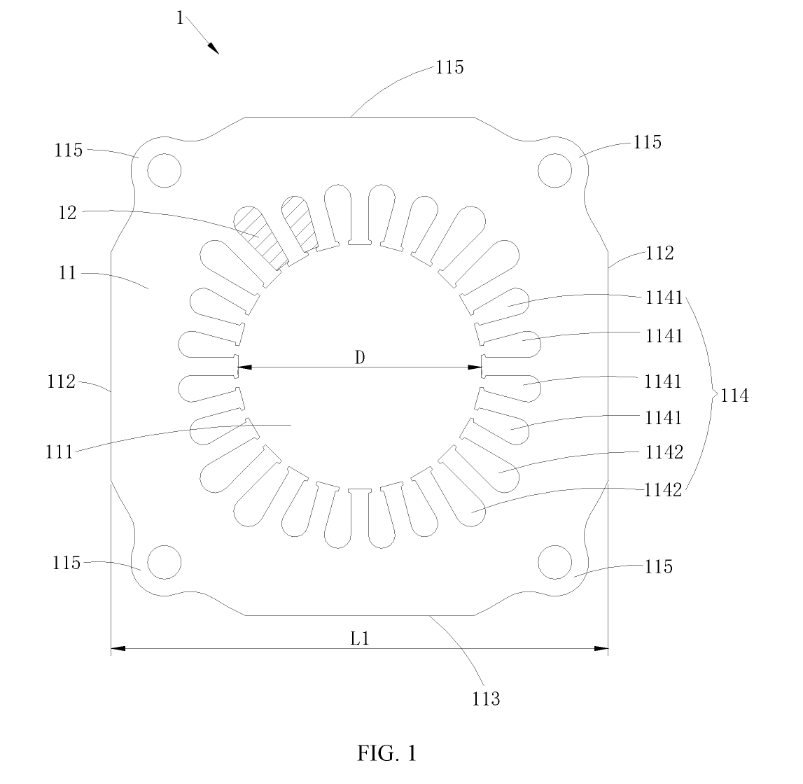

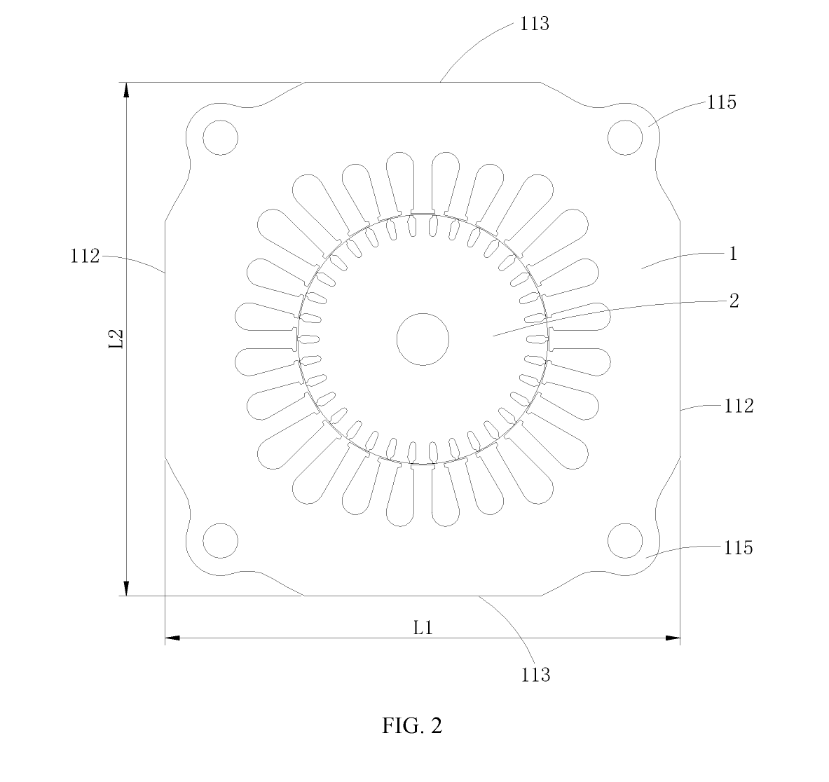

As shown in FIG. 1 and FIG. 2, a single phase induction motor for a washing machine according to an embodiment of the present disclosure includes a stator 1 and a rotor 2 rotationally fitted with the stator 1, the rotor 2 is of a squirrel cage type structure, the stator 1 includes a stator core 11 and a stator winding 12 disposed on the stator core 11, and the single phase induction motor has two poles, a synchronous speed of 3000 rpm (a power frequency of 50 Hz) or 3600 rpm (a power frequency of 60 Hz) and a rated speed ranging from 2200 rpm to 2800 rpm (the power frequency of 50 Hz) or ranging from 2600 rpm to 3400 rpm (the power frequency of 60 Hz). Through designing the single phase induction motor according to an embodiment of the present disclosure motor to be a two-pole motor, the synchronous speed of the single phase induction motor is raised to 3000 rpm (the power frequency of 50 Hz) or 3600 rpm (the power frequency of 60 Hz), i.e., is doubled as compared with the existing four-pole single phase induction motor, such that the output torque of the motor may be reduced by half under the same output power, and the volume of the motor may be reduced by about 20%, thereby effectively lowering the weight and cost of the motor, reducing the space occupied by the motor and thus increasing the internal space of the washing machine, such that it is possible to facilitate the optimization of the internal spatial structural design of the washing machine.

Alternatively, an inner hole 111 is formed inside the stator core 11 to allow the rotor 2 to pass through the inner hole 111, that is, the single phase induction motor in this embodiment is an internal rotor motor. The stator core 11 has a roughly square-shaped external contour and includes two first outer edges 112 opposite and parallel to each other and two second outer edges 113 opposite and parallel to each other, and a distance L1 between the two first outer edges 112 is less than or equal to a distance L2 between the two second outer edges 113. With the external contour design of the stator core 11 in this embodiment, not only is the uniform distribution of tooth yokes of the stator core 11 ensured, but also the contour size and weight of the stator core 11 are reduced, and thus the material utilization of the stator core 11 is increased.

Alternatively, a ratio of a diameter D of the inner hole 111 to the distance L1 between the two first outer edges 112 is less than or equal to 0.49:1. Such a ratio allows an optimized cost of the stator core 11 and the stator winding 12 and thus the reduced volume and cost of the motor.

Alternatively, the distance L1 between the two first outer edges 112 is 116±5 mm, and the stator core 11 has a height of 35±2.5 mm in an axial direction thereof. In such a way, it is possible to optimize the shape and tooth yoke distribution of the stator core 11 and effectively reduce the volume of the motor, and the weight of the stator core 11 may be reduced by about 20% under a premise that requirements of performance parameters of the motor are met.

Alternatively, the stator core 11 defines a plurality of winding slot groups 114 for accommodating the stator winding 12, each of the plurality of winding slot groups 114 includes four first slots 1141 and two second slots 1142, and a recessed depth of each second slot 1142 is greater than that of each first slot 1141. Further, in the same winding slot group 114, the two second slots 1142 are disposed adjacent to each other and located on the same side of the four first slots 1141. The recessed depth of the first slot 1141 or the second slot 1142 specifically refers to a depth of the first slot 1141 or the second slot 1142 extending from the inner hole 111 towards the outer edges of the stator core 11. For brief description, the first slots 1141 and the second slots 1142 all are collectively referred to as winding slots, i.e., the winding slot mentioned in embodiments of the present disclosure may refer to the first slots 1141 or the second slots 1142. In this embodiment, it is possible to improve the utilization of the winding slots by designing them into the first slots 1141 and the second slots 1142 with different recessed depths, and further to improve the efficiency of the motor and the uniformity of the tooth yoke distribution of the stator core 11.

Alternatively, a ratio of a slot surface area of each second slot 1142 to that of each first slot 1141 is greater than or equal to 1.36:1. Such a ratio allows an optimized distribution of tooth yokes of the stator core 11 and an improved material utilization of the stator core 11.

Alternatively, the stator core 11 defines four winding slot groups 114. Thus, the total number of the first slots 1141 and the second slots 1142 is 24, i.e., the number of the winding slots is 24. The stator core 11 has four corners 115 at outer edges thereof, the four corners 115 are located at four intersections of the two first outer edges 112 and the two second outer edges 113, respectively, and the second slots 1142 of the four winding slot groups 114 are opposite to the four corners 115 at the outer edges of the stator core 11, respectively. In such a way, it is possible to avoid partial stator yoke to be too thin due to the arrangement of the second slots 1142, and thus effectively prevent the magnetic path from being affected by the partial thin stator yoke, and ensure the uniformity of the tooth yoke distribution of the stator core 11.

Alternatively, the stator winding 12 is an aluminum winding. Thus, it is possible to lower the material cost of the stator winding 12 and thus the cost of the motor under a premise that the motor efficiency is satisfied. Certainly, in a specific application, the stator winding 12 may also be a copper winding.

Alternatively, the stator winding 12 includes a primary winding and a secondary winding, the first slots 1141 are each provided with the primary winding or the secondary winding therein, and the second slots 1142 are each provided with both the primary winding and the secondary winding therein. In such a way, it is possible to improve the utilization and space factor of the first slots 1141 and the second slots 1142. Certainly, in a specific application, the second slots 1142 also may be each provided with the primary winding or the secondary winding; alternatively, a part of the second slots 1142 are each provided with both the primary winding and the secondary winding, the other part of the second slots 1142 are each provided with the primary winding or the secondary winding.

Alternatively, the rotor 2 in an embodiment of the present disclosure is a squirrel cage type rotor. Specifically, the rotor 2 includes a shaft, a rotor core mounted on the shaft, and a rotor winding disposed on the rotor core. In this embodiment, the rotor winding is a squirrel cage type winding, which specifically is casted or produced by welding aluminum or copper strips with end rings, and thus has a simple structure and low price, and is durable and easy to maintain.

Further, in an embodiment of the present disclosure, there is also provided a washing machine, including a container (not shown) for accommodating clothes, a motor configured to drive the container to rotate, and a transmission control mechanism connected between the container and the motor (not shown), the motor is the single phase induction motor as described above, and the rotor 2 is connected with the container via the transmission control mechanism. As the washing machine, specifically a pulsator washing machine, according to embodiments of the present disclosure includes the single phase induction motor described above, the space occupied by the motor in the washing machine is reduced, and the internal effective space of the washing machine is increased, such that it is possible to facilitate the optimization of the internal structure of the washing machine and the improvement of the overall performance of the washing machine.

Alternatively, in this embodiment, the container rotates about a vertical axis, i.e., a rotation central axis of the container is the vertical axis, which may optimize the internal structure of the washing machine.

Alternatively, the transmission control mechanism includes a clutch connected with the rotor 2 and a reduction transmission component connected between the clutch and the container. The reduction transmission component includes a primary reduction member and a secondary reduction member, the single phase induction motor is configured to drive the container to rotate at a speed ranging from 750 rpm to 800 rpm through a transmission between the clutch and the primary reduction member; or the single phase induction motor is configured to drive the container to rotate at a speed ranging from 210 rpm to 260 rpm through a transmission among the clutch, the primary reduction member and the secondary reduction member. In this embodiment, the clutch may be used to cut off or transfer power from the single phase induction motor to the reduction transmission component on the one hand, and may also be used to switch a power transmission path of the single phase induction motor on the other hand. Specifically, the clutch may allow the power output by the single phase induction motor to be transferred to the container after the speed is reduced by the primary reduction member or by the primary reduction member and the secondary reduction member. In specific applications, under a dehydrating condition, the power output by the single phase induction motor is transferred via the clutch to the primary reduction member which slows down the rotation speed output by the single phase induction motor to 750 rpm to 800 rpm and transfers the power to container to allow the container to rotate at the speed ranging from 750 rpm to 800 rpm. Under a washing condition, the power output by the single phase induction motor is transferred via the clutch to the primary reduction member which slows down the rotation speed output by the single phase induction motor to 750 rpm to 800 rpm and transfers the power to the secondary reduction member, the secondary reduction member may slow down the rotation speed from the primary reduction member to 210 rpm to 260 rpm and transfers the power to the container to allow the container to rotate at the speed ranging from 210 rpm to 260 rpm.

Specifically, as compared with the existing washing machine including the four-pole single phase induction motor, the washing machine in this embodiment enables the container to rotate not only at the speed ranging from 750 rpm to 800 rpm under the dehydrating condition, but also at the speed ranging from 210 rpm to 260 rpm under the washing condition through increasing a reduction ratio of the primary reduction member from about 1.72 to a range of 2.5 to 3.5 and maintaining a reduction ratio of the secondary reduction member unchanged, thereby effectively meeting the requirements of rotation speeds of the washing machine under different working conditions. Moreover, as only the reduction ratio of the primary reduction member is changed, the washing machine has a simple structure which is easy to achieve.

Alternatively, in this embodiment, the primary reduction member is a belt transmission member, and the secondary reduction member is a gear transmission member, and therefore the smooth transmission and a compact structure may be achieved. Certainly, in a specific application, the primary reduction member and the secondary reduction member may also be a combination of other transmission members.

Although embodiments have been shown and described hereinbefore, it would be appreciated by those skilled in the art that the above embodiments are illustrative and cannot be construed to limit the present disclosure, and changes, alternatives, and modifications can be made in the embodiments without departing from spirit, principles and scope of the present disclosure.

What is claimed is:

1. A single phase induction motor for a washing machine, comprising:
a stator, comprising:
a stator core; and
a stator winding, disposed on the stator core; and
a rotor, rotationally fitted with the stator,
wherein the rotor is of a squirrel cage type structure, and the single phase induction motor has two poles, a synchronous speed of 3000 rpm or 3600 rpm, and a rated speed ranging from 2200 rpm to 2800 rpm or ranging from 2600 rpm to 3400 rpm.

2. The single phase induction motor according to claim 1, wherein an inner hole is formed inside the stator core to allow the rotor to pass through the inner hole, the stator core comprises two first outer edges opposite and parallel to each other and two second outer edges opposite and parallel to each other, a distance between the two first outer edges is less than or equal to a distance between the two second outer edges.

3. The single phase induction motor according to claim 2, wherein a ratio of a diameter of the inner hole to the distance between the two first outer edges is less than or equal to 0.49:1.

4. The single phase induction motor according to claim 2, wherein the distance between the two first outer edges is 116±5 mm.

5. The single phase induction motor according to claim 1, wherein the stator core defines a plurality of winding slot groups for accommodating the stator winding, each of the plurality of winding slot groups comprises four first slots and two second slots, and a recessed depth of each second slot is greater than that of each first slot.

6. The single phase induction motor according to claim 5, wherein in the same winding slot group, the two second slots are disposed adjacent to each other and located on the same side of the four first slots.

7. The single phase induction motor according to claim 5, wherein a ratio of a slot surface area of each second slot to that of each first slot is greater than or equal to 1.36:1.

8. The single phase induction motor according to claim 5, wherein the stator core defines four winding slot groups, the stator core has four corners at outer edges thereof, and the second slots of the four winding slot groups are opposite to the four corners at the outer edges of the stator core, respectively.

9. The single phase induction motor according to claim 6, wherein the stator core defines four winding slot groups, the stator core has four corners at outer edges thereof, and the second slots of the four winding slot groups are opposite to the four corners at the outer edges of the stator core, respectively.

10. The single phase induction motor according to claim 7, wherein the stator core defines four winding slot groups, the stator core has four corners at outer edges thereof, and the second slots of the four winding slot groups are opposite to the four corners at the outer edges of the stator core, respectively.

11. The single phase induction motor according to claim 5, wherein the stator winding comprises a primary winding and a secondary winding, the first slots are each provided with the primary winding or the secondary winding therein, the second slots are each provided with at least one of the primary winding or the secondary winding therein.

12. The single phase induction motor according to claim 6, wherein the stator winding comprises a primary winding and a secondary winding, the first slots are each provided with the primary winding or the secondary winding therein, the second slots are each provided with at least one of the primary winding or the secondary winding therein.

13. The single phase induction motor according to claim 7, wherein the stator winding comprises a primary winding and a secondary winding, the first slots are each provided with the primary winding or the secondary winding therein, the second slots are each provided with at least one of the primary winding or the secondary winding therein.

14. The single phase induction motor according to claim 9, wherein the stator winding comprises a primary winding and a secondary winding, the first slots are each provided with the primary winding or the secondary winding therein, the second slots are each provided with at least one of the primary winding or the secondary winding therein.

15. The single phase induction motor according to claim 9, wherein the stator winding comprises a primary winding and a secondary winding, the first slots are each provided with the primary winding or the secondary winding therein, the second slots are each provided with at least one of the primary winding or the secondary winding therein.

16. The single phase induction motor according to claim 10, wherein the stator winding comprises a primary winding and a secondary winding, the first slots are each provided with the primary winding or the secondary winding therein, the second slots are each provided with at least one of the primary winding or the secondary winding therein.

17. A washing machine, comprising:
a container;
a motor, configured to drive the container to rotate; and
a transmission control mechanism, connected between the container and the motor,
wherein the motor is a single phase induction motor, comprising:
a stator, comprising:
a stator core; and
a stator winding, disposed on the stator core; and
a rotor, rotationally fitted with the stator,
wherein the rotor is of a squirrel cage type structure, and the single phase induction motor has two poles, a synchronous speed of 3000 rpm or 3600 rpm, and a rated speed ranging from 2200 rpm to 2800 rpm or ranging from 2600 rpm to 3400 rpm,
wherein the rotor is connected with the container via the transmission control mechanism.

18. The washing machine according to claim 17, wherein a rotation central axis of the container is a vertical axis.

19. The washing machine according to claim 17, wherein the transmission control mechanism comprises a clutch connected with the rotor and a reduction transmission component connected between the clutch and the container.

20. The washing machine according to claim 19, wherein the reduction transmission component comprises a primary reduction member and a secondary reduction member, the single phase induction motor is configured to drive the container to rotate at a speed ranging from 750 rpm to 800 rpm through a transmission between the clutch and the primary reduction member; or the single phase induction motor is configured to drive the container to rotate at a speed ranging from 210 rpm to 260 rpm through a transmission among the clutch, the primary reduction member and the secondary reduction member.
